(19) United States
(12) Patent Application Publication
(10) Pub. No.: US 2014/0211702 A1
(43) Pub. Date: Jul. 31, 2014

(54) Apparatuses and Methods for a Communication System

(71) Applicant: Broadcom Corporation, Irvine, CA (US)

(72) Inventors: Samuli TURTINEN, Ii (FI); Sami-Jukka HAKOLA, Kempele (FI); Timo Kalevi KOSKELA, Oulu, (FI)

(73) Assignee: Broadcom Corporation, Irvine, CA (US)

(21) Appl. No.: 14/163,072

(22) Filed: Jan. 24, 2014

(30) Foreign Application Priority Data
Jan. 25, 2013 (GB) 1301366.9

(51) Int. Cl. H04W 72/02; H04W 76/02

(52) U.S. Cl. CPC H04W 72/02; H04W 76/023
USPC 370/329

(57) ABSTRACT

A method, apparatus and computer program product are provided herein for enabling ProSe discovery via one or more signal range classes. In some example embodiments, a method is provided that comprises determining a signal range class to be associated with one or more applications based at least on one or more signal range classes that are authorized by a network entity. In some example embodiments, the signal range class is assigned a logical channel. The method of this embodiment may also include causing two or more service data units received from the one or more applications to be multiplexed into a protocol data unit based on the signal range class associated with the one or more applications. The method of this embodiment may also include causing the protocol data unit to be processed via the logical channel associated with the signal range class.

### TECHNICAL FIELD

The present invention relates to apparatuses and methods for a communication system. Embodiments of the present invention relate generally to communications technology and, more particularly, to example logical channel mapping.

### BACKGROUND

The modern computing era has brought about a tremendous expansion in computing power as well as increased affordability of computing devices. This expansion in computing power has led to a reduction in the size of computing devices and given rise to a new generation of mobile devices that are capable of performing functionality that only a few years ago required processing power provided only by the most advanced desktop computers. Consequently, mobile computing devices having a small form factor have become ubiquitous and are used by consumers of all socioeconomic backgrounds.

As a result of the expansion in computing power and the reduction in size of mobile computing devices, mobile computing devices are being marketed with an ever increasing array of features. For example, one such feature is the ability for mobile terminals to have access to or otherwise use proximity services. In some examples proximity services may include mobile terminal discovery (e.g. discovery of another communication device in a given proximity), communication paths between discovered mobile terminals, such as via device-to-device (D2D) connections, and/or the like.

A D2D connection is operable to enable a mobile terminal to be in direct data communication with another mobile terminal, via the cellular spectrum, without using the one or more base stations within a cellular network. The use of D2D connections enables the transfer of data between mobile terminals over a short distance while avoiding the potential of overloading the cellular network.

### SUMMARY

In some example embodiments, a method is provided that comprises determining a signal range class to be associated with one or more applications based at least on one or more signal range classes that are authorized by a network entity. In some example embodiments, the signal range class is assigned a logical channel. The method of this embodiment may also include causing two or more service data units received from the one or more applications to be multiplexed into a protocol data unit based on the signal range class associated with the one or more applications. The method of this embodiment may also include causing the protocol data unit to be processed via the logical channel associated with the signal range class.

In further example embodiments, an apparatus is provided that includes at least one processor and at least one memory including computer program code with the at least one memory and the computer program code being configured, with the at least one processor, to cause the apparatus to at least determine a signal range class to be associated with one or more applications based at least on one or more signal range classes that are authorized by a network entity. In some example embodiments, the signal range class is assigned a logical channel. The at least one memory and computer program code may also be configured to, with the at least one processor, cause the apparatus to cause two or more service data units received from the one or more applications to be multiplexed into a protocol data unit based on the signal range class associated with the one or more applications. The at least one memory and computer program code may also be configured to, with the at least one processor, cause the apparatus to cause the protocol data unit to be processed via the logical channel associated with the signal range class.

In yet further example embodiments, a computer program product may be provided that includes at least one non-transitory computer-readable storage medium having computer-readable program instructions stored therein with the computer-readable program instructions including program instructions configured to determine a signal range class to be associated with one or more applications based at least on one or more signal range classes that are authorized by a network entity. In some example embodiments, the signal range class is assigned a logical channel. The computer-readable program instructions may also include program instructions configured to cause two or more service data units received from the one or more applications to be multiplexed into a protocol data unit based on the signal range class associated with the one or more applications. The computer-readable program instructions may also include program instructions configured to cause the protocol data unit to be processed via the logical channel associated with the signal range class.

In yet further example embodiments, an apparatus is provided that includes means for determining a signal range class to be associated with one or more applications based at least on one or more signal range classes that are authorized by a network entity. In some example embodiments, the signal range class is assigned a logical channel. The apparatus of this embodiment may also include means for causing two or more service data units received from the one or more applications to be multiplexed into a protocol data unit based on the signal range class associated with the one or more applications. The apparatus of this embodiment may also include means for causing the protocol data unit to be processed via the logical channel associated with the signal range class.

In some example embodiments, a method is provided that comprises receiving at least one protocol data unit. The method of this embodiment may also include determining a signal range class of one or more signal range classes associated with the at least one protocol data unit. The method of this embodiment may also include causing one or more service data units multiplexed in the at least one protocol data unit to be processed via a logical channel associated with the determined signal range class.

In further example embodiments, an apparatus is provided that includes at least one processor and at least one memory including computer program code with the at least one memory and the computer program code being configured, with the at least one processor, to cause the apparatus to at least receive at least one protocol data unit. The at least one memory and computer program code may also be configured to, with the at least one processor, cause the apparatus to determine a signal range class of one or more signal range classes associated with the at least one protocol data unit. The at least one memory and computer program code may also be configured to, with the at least one processor, cause the apparatus to cause one or more service data units multiplexed in the at least one protocol data unit to be processed via a logical channel associated with the determined signal range class.

In yet further example embodiments, a computer program product may be provided that includes at least one non-transitory computer-readable storage medium having computer-readable program instructions stored therein with the computer-readable program instructions including program instructions configured to receive at least one protocol data unit. The computer-readable program instructions may also include program instructions configured to determine a signal range class of one or more signal range classes associated with the at least one protocol data unit. The computer-readable program instructions may also include program instructions configured to cause one or more service data units multiplexed in the at least one protocol data unit to be processed via a logical channel associated with the determined signal range class.

In yet further example embodiments an apparatus is provided that includes means for receiving at least one protocol data unit. The apparatus of this embodiment may also include means for determining a signal range class of one or more signal range classes associated with the at least one protocol data unit. The apparatus of this embodiment may also include means for causing one or more service data units multiplexed in the at least one protocol data unit to be processed via a logical channel associated with the determined signal range class.

In some example embodiments, a method is provided that comprises determining a logical channel of one or more logical channels to be associated with a signal range class of one or more signal range classes. The method of this embodiment may also include causing an indication of a logical channel associated with a signal range class of the one or more signal range classes to be transmitted to a mobile terminal. In some example embodiments, the mobile terminal is configured to assign one or more applications to a signal range class of the one or more signal range classes.

In further example embodiments, an apparatus is provided that includes at least one processor and at least one memory including computer program code with the at least one memory and the computer program code being configured, with the at least one processor, to cause the apparatus to at least determine a logical channel of one or more logical channels to be associated with a signal range class of one or more signal range classes. The at least one memory and computer program code may also be configured to, with the at least one processor, cause the apparatus to cause an indication of a logical channel associated with a signal range class of the one or more signal range classes to be transmitted to a mobile terminal. In some example embodiments, the mobile terminal is configured to assign one or more applications to a signal range class of the one or more signal range classes.

In yet further example embodiments, a computer program product may be provided that includes at least one non-transitory computer-readable storage medium having computer-readable program instructions stored therein with the computer-readable program instructions including program instructions configured to determine a logical channel of one or more logical channels to be associated with a signal range class of one or more signal range classes. The computer-readable program instructions may also include program instructions configured to cause an indication of a logical channel associated with a signal range class of the one or more signal range classes to be transmitted to a mobile terminal. In some example embodiments, the mobile terminal is configured to assign one or more applications to a signal range class of the one or more signal range classes.

In yet further example embodiments, an apparatus is provided that includes means for determining a logical channel of one or more logical channels to be associated with a signal range class of one or more signal range classes. The apparatus of this embodiment may also include means for causing an indication of a logical channel associated with a signal range class of the one or more signal range classes to be transmitted to a mobile terminal. In some example embodiments, the mobile terminal is configured to assign one or more applications to a signal range class of the one or more signal range classes.

### BRIEF DESCRIPTION OF THE DRAWINGS

Having thus described the example embodiments of the invention in general terms, reference will now be made to the accompanying drawings, which are not necessarily drawn to scale, and wherein:

FIG. 1 is a schematic representation of a system having a mobile terminal that may benefit from some example embodiments of the present invention;

FIG. 2 is a block diagram of an apparatus that may be embodied by a mobile terminal and/or a base station in accordance with some example embodiments of the present invention;

FIG. 3 illustrates various examples of a mobile terminal radio stack in accordance with some example embodiments of the present invention;

FIG. 4 is a flowchart illustrating operations performed by an example transmitting mobile terminal in accordance with some example embodiments of the present invention;

FIG. 5 is a flowchart illustrating operations performed by an example base station in accordance with some example embodiments of the present invention;

FIG. 6 is a flowchart illustrating operations performed by an example receiving mobile terminal in accordance with some example embodiments of the present invention; and

FIG. 7 is a signal flow diagram illustrating operations performed in accordance with some example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

In some examples, proximity services (ProSe) may include, but are not limited to ProSe Discovery, which, for example, is a process that identifies that a mobile terminal is in proximity of another mobile terminal, using a network, such as a Evolved Universal Terrestrial Radio Access Network (E-UTRAN) and ProSe Communication, which, for example, is a communication between two or more mobile terminals that are in proximity by means of a communication path established between the mobile terminals. In some examples, the path for discovery and communication between mobile terminals may be established directly between mobile terminals or may be network based (e.g. routed via local base stations).

In some examples, and as is described herein, ProSe discovery and communications, such as ProSe discovery and communications via a direct link between two or more mobile terminals or ProSe discovery and communications via a network, may be configured to support one or more signal range classes. In some examples, the supported or otherwise authorized signal range classes may be split into multiple signal ranges classes (e.g. a short range, medium range and maximum range). As such, in order to enable the use of multiple range classes, a network, such as E-UTRAN, via one or more base stations, may be operable to configure at least one logical channel for each of the one or more signal range classes and transmit an indication of the at least one logical channel assigned to each of the authorized signal ranges classes to a mobile terminal. In some examples, a logical channel prioritization parameter may also be configured for each of the one or more signal range classes and transmitted to the mobile terminal.

In some example embodiments, a mobile terminal may be configured to determine or otherwise receive an indication of the one or more authorized signal range classes and the respective one or more logical channels assigned to each of the one or more signal range classes (e.g. multiple logical channels may be configured for a particular signal range class) from a base station, the network or the like. As such, the mobile terminal will then be operable to receive requests from one or more applications executing on the mobile terminal for use of the one or more range classes for the purpose of ProSe discovery and/or communication.

Based on the one or more requests from the one or more applications for use of the one or more range classes for the purposes of ProSe discovery and/or communication, the mobile terminal may further be configured to indicate a logical channel, via a logical channel identification (LCID), that is to be used by a particular application. As such, the mobile terminal may then be operable to process one or more service data units (SDUs) from the one or more applications based on the assigned LCID.

Alternatively or additionally, a protocol data unit (PDU) header, such as a MAC header may be configured such that the header (e.g. a control unit defined by the header) is configured to indicate signal range class used by the PDU. In some examples, the MAC header may indicate physical layer resources that are allocated for each range class, such as, for example, a separation in time domain or power levels, such that the receiving mobile terminal may be configured to determine the range class of any received PDUs and may then be able to process those PDUs.

In further examples, the mobile terminal, such as via MAC layer, may be configured to multiplex one or more SDUs associated with different range classes to a same protocol data unit (PDU). In such examples, the signal range class of the multiplexed PDU may be configured based on the service requirements (e.g., transmission power, discovery resources and/or the like). For example, the shortest range class of the signal range classed defined by the multiplexed SDUs may be selected as the signal range class of the PDU. Advantageously, the ability to multiplex SDUs having different range classes may for example, enable an application to generate discovery SDUs using different signal range classes.

Alternatively or additionally, a single logical channel may be assigned. In such cases, a MAC header may indicate a particular range class to be used for discovery and for processing of a received PDU.

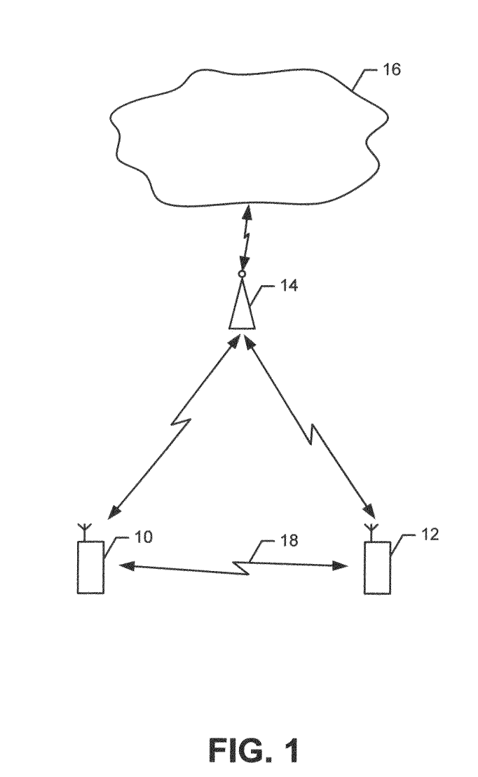

Although the method, apparatus and computer program product as described herein may be implemented in a variety of different systems, one example of such a system is shown in FIG. 1, which includes a mobile terminal (e.g., mobile terminal 10 and/or mobile terminal 12) that is capable of communication via a base station 14, such as an access point, a macro cell, a Node B, an eNB, Base Transceiver Station (BTS), a coordination unit, a macro base station or other base station, with a network 16 (e.g., a core network). While the network may be configured in accordance with Global System for Mobile Communications (GSM), other networks, such as LTE™ or LTE-Advanced (LTE-A™), may support the method, apparatus and computer program product of some embodiments of the present invention including those configured in accordance with wideband code division multiple access (W-CDMA™), CDMA2000, general packet radio service (GPRS™), IEEE™ 802.11 standard for wireless fidelity (WiFi), wireless local access network (WLAN™) Worldwide Interoperability for Microwave Access (WiMAX™) protocols, and/or the like.

The network 16 may include a collection of various different nodes, devices or functions that may be in communication with each other via corresponding wired and/or wireless interfaces. For example, the network 16 may include one or more cells, including base station 14, which may serve a respective coverage area. The base station 14 may be, for example, part of one or more cellular or mobile networks or public land mobile networks (PLMNs). In turn, other devices such as processing devices (e.g., personal computers, server computers or the like) may be coupled to the mobile terminal 10, mobile terminal 12 and/or other communication devices via the network 16. The network 16 may also include a mobility management entity (MME), a ProSe server, a home subscriber server (HSS) and/or the like.

A mobile terminal, such as the mobile terminal 10 and/or mobile terminal 12 (also known as user equipment (UE), a communications device or the like), may be in communication with other mobile terminals or other devices via the base station 14 and, in turn, the network 16. In some cases, the mobile terminal 10 may include an antenna or a plurality of antennas for transmitting signals to, and for receiving signals from, a base station 14. Mobile terminal 10 and/or mobile terminal 12 are further configured for mobile terminal discovery and/or direct communications (e.g. D2D communications) via link 18.

In some example embodiments, the mobile terminal 10 and/or mobile terminal 12 may be a mobile communication device such as, for example, a mobile telephone, portable digital assistant (PDA), pager, laptop computer, STA, a tablet, or any of numerous other hand held or portable communication devices, computation devices, content generation devices, content consumption devices, or combinations thereof. Other such devices that are configured to connect to the network include, but are not limited to a refrigerator, a security system, a home lighting system, and/or the like. As such, the mobile terminal 10 and/or mobile terminal 12 may include one or more processors that may define processing circuitry and a processing system, either alone or in combination with one or more memories. The processing circuitry may utilize instructions stored in the memory to cause the mobile terminal 10 and/or mobile terminal 12 to operate in a particular way or execute specific functionality when the instructions are executed by the one or more processors. The mobile terminal 10 and/or mobile terminal 12 may also include communication circuitry and corresponding hardware/software to enable communication with other devices and/or the network 16.

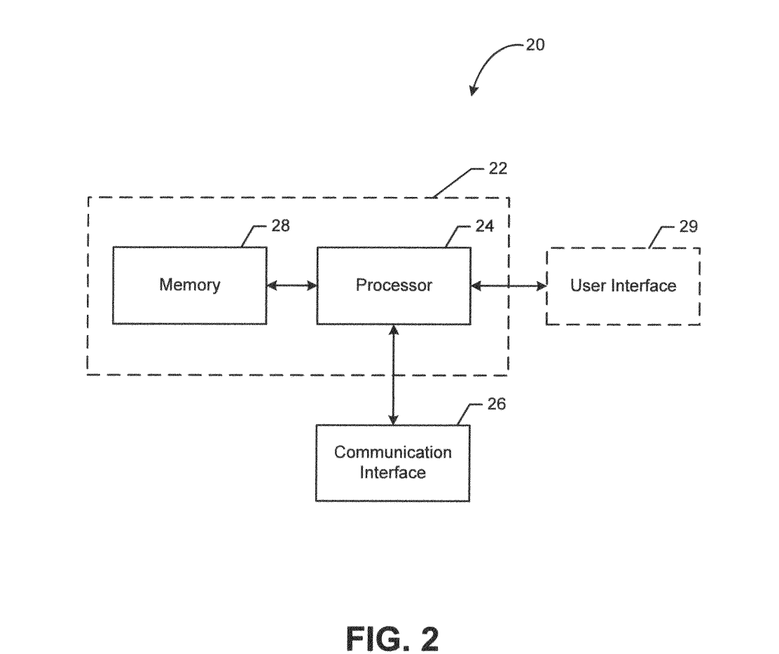

In some example embodiments, the mobile terminal 10, the mobile terminal 12 and/or the base station 14 may be embodied as or otherwise include an apparatus 20 as generically represented by the block diagram of FIG. 2. While the apparatus 20 may be employed, for example, by a mobile terminal 10, mobile terminal 12 or a base station 14, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry 22 may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 28 that may be in communication with or otherwise control a communication interface 26 and, in some cases, a user interface 29. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal. In some examples, the processing circuitry 22 and/or the processor 24 make take the form of a processing system in some example embodiments.

The user interface 29 (if implemented) may be in communication with the processing circuitry 22 to receive an indication of a user input at the user interface and/or to provide an audible, visual, mechanical or other output to the user. As such, the user interface may include, for example, a keyboard, a mouse, a trackball, a display, a touch screen, a microphone, a speaker, and/or other input/output mechanisms. The apparatus 20 need not always include a user interface. For example, in instances in which the apparatus is embodied as a base station 14, the apparatus may not include a user interface. As such, the user interface is shown in dashed lines in FIG. 2.

The communication interface 26 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 16 and/or any other device or module in communication with the processing circuitry 22, such as between the mobile terminal 10, mobile terminal 12 and the base station 14. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 28 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 28 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor 24 may be specifically configured hardware for conducting the operations described herein. Alternatively, as another example, when the processor 24 is embodied as an executor of software instructions, the instructions may specifically configure the processor 24 to perform the operations described herein.

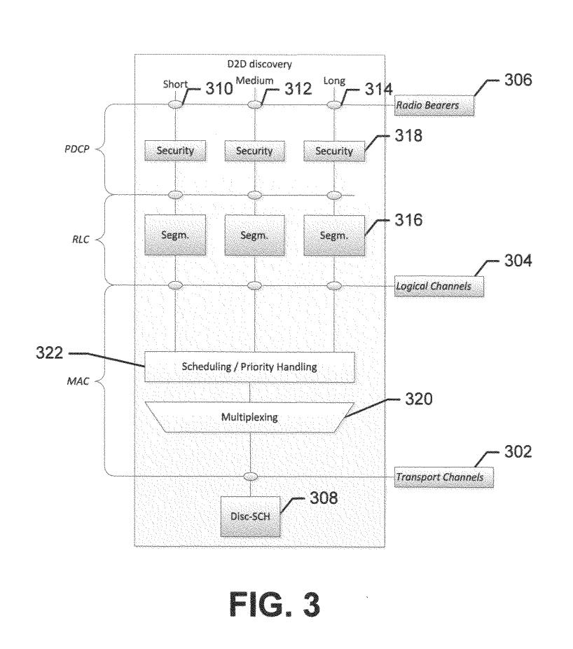

FIG. 3 illustrates an example of a mobile terminal radio stack in accordance with some example embodiments of the present invention. In some examples and in an instance in which there are multiple signal range classes e.g. a short range, a medium range and a long range) authorized by a network, such as via a base station, a discovery signal channel 308 may be configured on the transport channel layer 302 and one or more radio bearers 306, such as one or more short range bearers 310, one or more medium range bearers 312 and one or more long range bearers 314 may be established by the mobile terminal. Each of a short range bearer 310, medium range bearer 312 and long range bearer 314 may be configured to be associated with a logical channel 304.

The example mobile terminal radio stack for short range bearer 310, medium range bearer 312 and/or long range bearer 314, as shown with reference to FIG. 3, illustrates a MAC layer, a radio link control (RLC) layer and a packet data convergence protocol (PDCP) layer. The MAC layer includes transport channels 302, a multiplexing entity 320 and scheduling/priority handling 322. The RLC layer comprises an RLC entity that provides automatic repeat request (ARQ) functionality 316 and supports data segmentation and concatenation. The PDCP layer comprises a PDCP entity that is configured to perform a security function 318, such as encoding and decoding of the user plane and control plane data.

In some examples the multiplexing entity 320 may be configured to multiplex SDUs from logical channels 304 that are associated with the same signal range class to a same PDU or set of related PDUs. Alternatively or additionally, the multiplexing entity 320 may be configured to multiplex SDUs from logical channels 304 that are associated with different signal range classes to a same PDU or set of PDUs. As such, and in some examples, a PDU having SDUs associated with different range classes, may be processed by the mobile terminal based on service requirements (e.g., transmission power, discovery resources and/or the like) relating to a particular signal range class multiplexed in the PDU, such as the shortest signal range class.

In some examples, a single LCID may be assigned for a signal range class. Alternatively or additionally, a MAC CE or a MAC header, such as a MAC subheader, of the constructed PDU may be configured to include an indication of the range class of the discovery signal. As such, a MAC layer of the discovery signal receiver mobile terminal, such as mobile terminal 12, may then be configured to forward the received discovery signals according to the identified range classes to corresponding logical channels for higher layers in the stack to process. In an instance in which a discovery signal receiver mobile terminal is not authorized to receive a particular range class, for example long range class discovery signals, the MAC layer of the receive mobile terminal may be configured to discard any received PDUs associated with the particular signal range class.

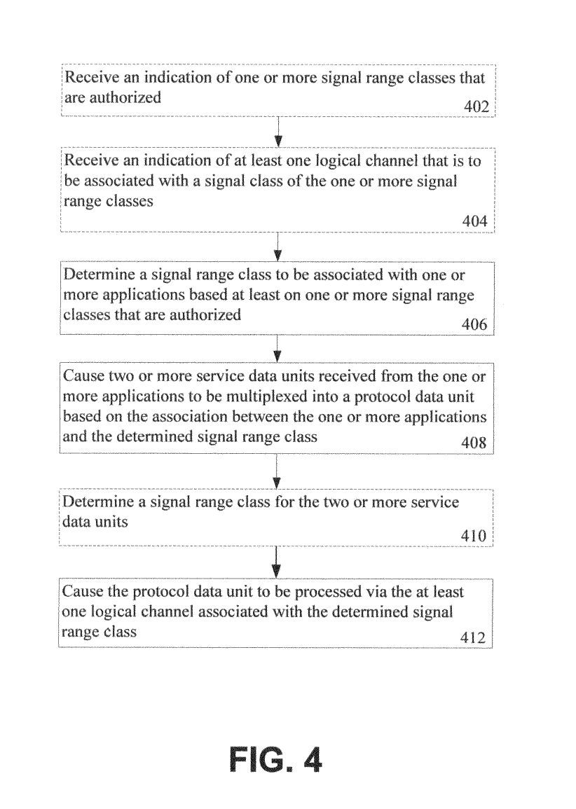

FIGS. 4 to 6 illustrate example operations performed by a method, apparatus and computer program product, such as apparatus 20 of FIG. 2 in accordance with one embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described herein may be embodied by computer program instructions. In this regard, the computer program instructions which embody the procedures described herein may be stored by a memory 28 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 4 to 6, when executed, convert a computer or processing circuitry into a particular machine configured to perform an example embodiment of the present invention. Accordingly, the operations of FIGS. 4 to 6 define an algorithm for configuring a computer or processing circuitry 22, e.g., processing system, to perform an example embodiment. In some cases, a general purpose computer may be provided with an instance of the processor which performs the algorithm of FIGS. 4 to 6 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations herein either alone or in combination with any others among the features described herein.

FIG. 4 is a flowchart illustrating operations performed by an example transmitting mobile terminal, such as mobile terminal 10 and/or mobile terminal 12, or a component of a transmitting mobile terminal, such as the processing circuitry 22, the processor 24, the communications interface 26, a modem and/or the like, in accordance with some example embodiments of the present invention. As is shown with respect to operation 402, the apparatus 20 embodied, for example by mobile terminal 10 and/or mobile terminal 12, may include means, such as the processing circuitry 22, the processor 24, the communications interface 26, or the like, for receiving an indication of one or more signal range classes that are authorized by the network. As is shown with respect to operation 404, the apparatus 20 embodied, for example by mobile terminal 10 and/or mobile terminal 12, may include means, such as the processing circuitry 22, the communications interface 26, the processor 24 or the like, for receiving an indication of the at least one logical channel that is to be associated with a signal range class of the one or more signal range classes.

As is shown with respect to operation 406, the apparatus 20 embodied, for example by mobile terminal 10 and/or mobile terminal 12, may include means, such as the processing circuitry 22, the processor 24 or the like, for determining a signal range class to be associated with one or more applications based at least on one or more signal range classes that are authorized by a network entity. In some example embodiments, each signal range class is assigned one or more logical channels, however in other example embodiments a single LCID is assigned to each signal range class.

As is shown with respect to operation 408, the apparatus 20 embodied, for example by mobile terminal 10 and/or mobile terminal 12, may include means, such as the processing circuitry 22, the processor 24 or the like, for causing two or more service data units received from the one or more applications to be multiplexed into a protocol data unit based on the association between the one or more applications and the determined signal range class. In some example embodiments, the two or more service data units are multiplexed in an instance in which the two or more service data units are generated by applications that are associated with the same signal range class. In some examples, at least one of a MAC CE or a MAC header of a PDU having at least one SDU comprises an identification of the signal range class. As such, the identification of the signal range class enables a MAC layer of a receiving mobile terminal to forward a protocol data unit to the logical channel associated with the signal range class.

In an instance in which the two or more service data units are generated by applications that are associated with different signal range classes, as is shown with respect to operation 410, the apparatus 20 embodied, for example by mobile terminal 10 and/or mobile terminal 12, may include means, such as the processing circuitry 22, the processor 24 or the like, for determining a signal range class for the two or more service data units. In some example embodiments, the determined signal range class for the two or more service data units is based on one or more service requirements, such as the range class that has the shortest signal range when compared to the other signal range classes.

As is shown with respect to operation 412, the apparatus 20 embodied, for example by mobile terminal 10 and/or mobile terminal 12, may include means, such as the processing circuitry 22, the processor 24 or the like, for causing the protocol data unit to be processed via the at least one logical channel associated with the determined signal range class. In some examples, one or more protocol data units may be discarded by a receiving mobile terminal in an instance in which the signal receiver is not configured to receive packet data units associated with a particular signal range class and the one or more protocol data units are of that particular signal range class. In some example embodiments, a logical channel prioritization parameter may also be provided by the network, such as via a base station and defines a priority for the one or more signal range classes. The logical channel prioritization parameter may be then configured to allocate resources to the one or more logical channels based on a decreasing priority order.

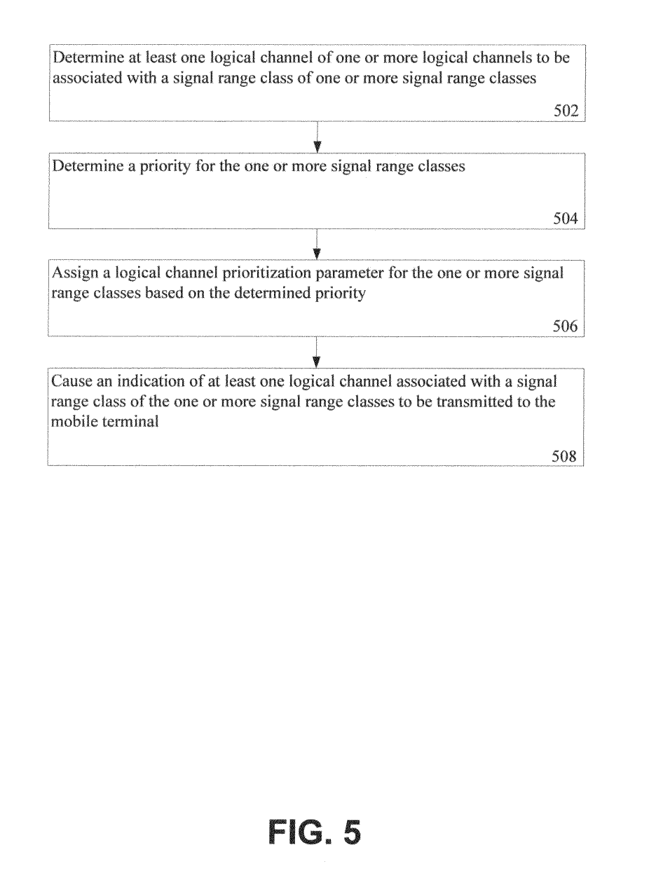

FIG. 5 is a flowchart illustrating operations performed by an example base station in accordance with some example embodiments of the present invention. As is shown with respect to operation 502, the apparatus 20 embodied, for example by base station 14, may include means, such as the processing circuitry 22, the processor 24 or the like, for determining at least one logical channel of one or more logical channels to be associated with a signal range class of one or more signal range classes. In some example embodiments, the apparatus 20 embodied, for example by base station 14, may include means, such as the processing circuitry 22, the processor 24 or the like is configured to assign an LCID or multiple LCIDs to at least one, but in some examples each, of the signal range classes.

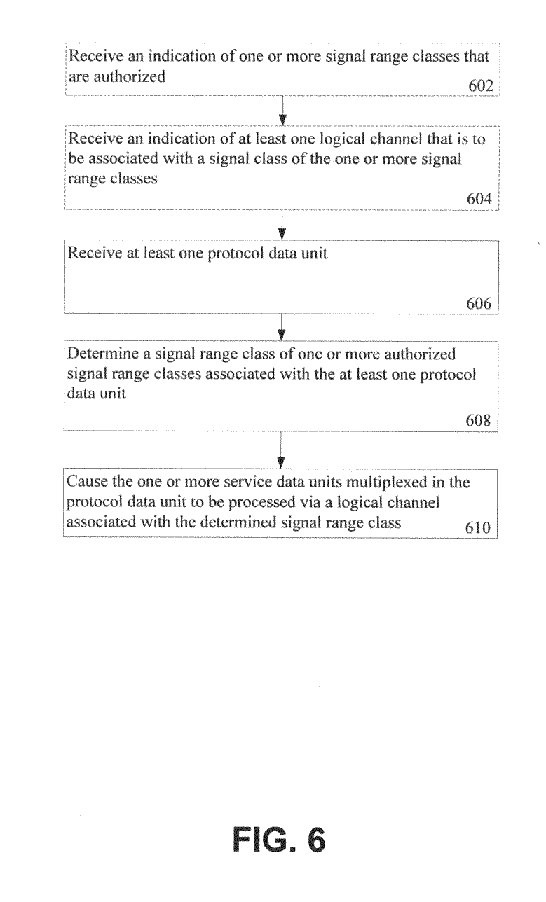

As is shown with respect to operation 504, the apparatus 20 embodied, for example by base station 14, may include means, such as the processing circuitry 22, the processor 24 or the like, for determining a priority for the one or more signal range classes. As is shown with respect to operation 506, the apparatus 20 embodied, for example by base station 14, may include means, such as the processing circuitry 22, the processor 24 or the like, for assigning a logical channel prioritization parameter for the one or more signal range classes based on the determined priority. As is shown with respect to operation 508, the apparatus 20 embodied, for example by base station 14, may include means, such as the processing circuitry 22, the processor 24, the communication interface 26 or the like, for causing an indication of at least one logical channel associated with a signal range class of the one or more signal range classes to be transmitted to the mobile terminal. In some examples, the mobile terminal is configured to assign one or more applications to a signal range class of the one or more signal range classes, such as is described with reference to FIG. 6.

FIG. 6 is a flowchart illustrating operations performed by an example receiving mobile terminal, such as mobile terminal 10 and/or mobile terminal 12, or a component of a receiving mobile terminal, such as the processing circuitry 22, the processor 24, the communications interface 26, a modem and/or the like, in accordance with some example embodiments of the present invention. As is shown with respect to operation 602, the apparatus 20 embodied, for example by mobile terminal 10 and/or mobile terminal 12, may include means, such as the processing circuitry 22, the processor 24, the communications interface 26 or the like, for receiving an indication of one or more signal range classes that are authorized by the network. As is shown with respect to operation 604, the apparatus 20 embodied, for example by mobile terminal 10 and/or mobile terminal 12, may include means, such as the processing circuitry 22, the processor 24, the communications interface 26 or the like, for receiving an indication of the at least one logical channel that is to be associated with a signal range class of the one or more signal range classes. As is shown with respect to operation 606, the apparatus 20 embodied, for example by mobile terminal 10 and/or mobile terminal 12, may include means, such as the processing circuitry 22, the processor 24, the communications interface 26 or the like, for receiving at least one protocol data unit.

As is shown with respect to operation 608, the apparatus 20 embodied, for example by mobile terminal 10 and/or mobile terminal 12, may include means, such as the processing circuitry 22, the processor 24 or the like, for determining a signal range class of one or more authorized signal range classes associated with the at least one protocol data unit. In some example embodiments a single LCID or multiple LCIDs are suggestive of a particular signal range class. In some example embodiments, at least one of a medium access control element or a medium access control header of a protocol data unit having at least one service data unit comprises an identification of the signal range class for the one or more service data units. As is shown with respect to operation 610, the apparatus 20 embodied, for example by mobile terminal 10 and/or mobile terminal 12, may include means, such as the processing circuitry 22, the processor 24 or the like, for causing the one or more service data units multiplexed in the protocol data unit to be processed via a logical channel associated with the determined range class. In some example embodiments, PDUs from signal range classes that are not authorized are discarded by a MAC layer.

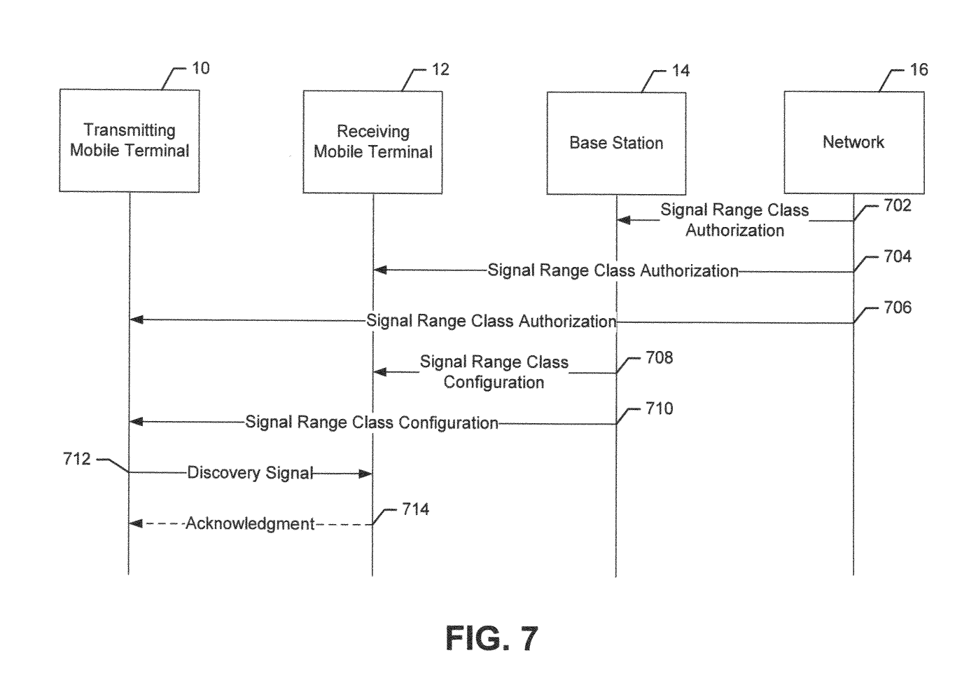

FIG. 7 is a signal flow diagram illustrating operations performed in accordance with some example embodiments of the present invention. In some examples embodiments, the network 16, such as via an MME, a ProSe server, an HSS and or the like, may be configured to signal one or more authorized range classes for one or more mobile terminals in one or more signal range class authorization signals, such as signal range class authorization signals 702-706. In some example embodiments, the network 16 may directly signal the mobile terminals as is shown with reference to signals 704 and 706, whereas in other example embodiments the network 16 may route the signal range class authorization through the base station 14. Alternatively or additionally, in some example embodiments, the authorized signal range classes may be provided via mobile terminal subscription data provided by, for example, the base station 14.

In some example embodiments, the base station 14 may be operable to provide signal range class configuration information (e.g. an indication of those signal range classes that have been authorized by a network) to a transmitting mobile terminal 10 and a receiving mobile terminal 12 in signals 708 and 710. In response to signals 708 and 710, a transmitting mobile terminal 10 may grant one or more applications the use of one or more of the authorized signal range classes for use in discovery of, for example, receiving mobile terminal 12. As such, a discovery signal 712, in the form of, for example, one or more PDUs, may be transmitted to receiving mobile terminal 12. In response, and in some example embodiments, upon receipt of the discovery signal 712, the receiving mobile terminal may provide an acknowledgement 714.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for use in a communication system, the method comprising:
determining a signal range class to be associated with one or more applications based at least on one or more signal range classes that are authorized by a network entity, wherein the signal range class is assigned a logical channel;
causing two or more service data units received from the one or more applications to be multiplexed into a protocol data unit based on the signal range class associated with the one or more applications; and
causing the protocol data unit to be processed via the logical channel associated with the signal range class.

2-13. (canceled)

14. An apparatus for a communication system, the apparatus comprising:
a processing system that comprises at least one data processor and at least one computer-readable memory storing a computer program, wherein the processing system is arranged to cause the apparatus to at least:
determine a signal range class to be associated with one or more applications based at least on one or more signal range classes that are authorized by a network entity, wherein the signal range class is assigned a logical channel;
cause two or more service data units received from the one or more applications to be multiplexed into a protocol data unit based on the signal range class associated with the one or more applications; and
cause the protocol data unit to be processed via the logical channel associated with the signal range class.

15. An apparatus according to claim 14, wherein the processing system is arranged to cause the apparatus to:
receive an indication of one or more signal range classes that are authorized by the network entity; and
receive an indication of the logical channel that is to be associated with a signal range class of the one or more signal range classes.

16. An apparatus according to claim 14, wherein the two or more service data units are multiplexed in an instance in which the two or more service data units are generated by applications that are associated with the same signal range class.

17. An apparatus according to claim 14, wherein the two or more service data units are multiplexed in an instance in which the two or more service data units are generated by applications that are associated with different signal range classes.

18. An apparatus according to claim 17, wherein the processing system is arranged to cause the apparatus to:
determine a signal range class for the protocol data unit that comprises the two or more service data units that are associated with the different signal range classes.

19. An apparatus according to claim 18, wherein the signal range class for the protocol data unit is determined based on one or more service requirements.

20. An apparatus according to claim 18, wherein the signal range class for the protocol data unit is determined based on the signal range class that has a shortest signal range when compared to other signal range classes that are authorized.

21. An apparatus according to claim 14, wherein at least one of a medium access control element or a medium access control header of a protocol data unit having at least one service data unit comprises an identification of the signal range class.

22. An apparatus according to claim 21, wherein the identification of the signal range class is configured to enable a medium access control layer to forward a protocol data unit based on the identification of the signal range class and an associated logical channel.

23. An apparatus according to claim 14, wherein one or more protocol data units are configured to be discarded by a signal receiver in an instance in which the signal receiver is not configured or authorized to receive packet data units associated with a particular signal range class and the one or more protocol data units are of the particular signal range class.

24. An apparatus according to claim 14, wherein a logical channel prioritization parameter defines a priority for the one or more signal range classes.

25. An apparatus according to claim 14, wherein the one or more signal range classes are one or more discovery signal range classes.

26. An apparatus according to claim 14, wherein the network entity that is operable to authorize one or more signal range classes is a mobility management entity, a base station, a proximity services server or a home subscriber server.

27. An apparatus according to claim 14, wherein the apparatus comprises at least one of a user equipment and a communications device.

28. An apparatus according to claim 14, wherein the apparatus is configured for use in at least one of global system for mobile communications, wideband code division multiple access, time division synchronous code division multiple access, a long term evolution or long term evolution advanced system.

29-87. (canceled)

88. An apparatus for a communication system, the apparatus comprising:
a processing system that comprises at least one data processor and at least one computer-readable memory storing a computer program, wherein the processing system is arranged to cause the apparatus to at least:
determine a logical channel of one or more logical channels to be associated with a signal range class of one or more signal range classes; and
cause an indication of a logical channel associated with a signal range class of the one or more signal range classes to be transmitted to a mobile terminal, wherein the mobile terminal is configured to assign one or more applications to a signal range class of the one or more signal range classes.

89. An apparatus according to claim 88, wherein a logical channel identification is assigned for each of the one or more signal range classes.

90. An apparatus according to claim 88, wherein the processing system is arranged to cause the apparatus to:
determine a priority for the one or more signal range classes; and
assign a logical channel prioritization parameter for the one or more signal range classes based on the determined priority.

91. An apparatus according to claim 88, wherein the apparatus comprises at least one of a base station, a node B, an enhanced node B, a mobility management entity, a proximity services server or a home subscriber server.

92-100. (canceled)
